(19) United States
(12) Patent Application Publication
(10) Pub. No.: US 2011/0315696 A1
(43) Pub. Date: Dec. 29, 2011

(54) MODULAR RAINWATER COLLECTION SYSTEM AND METHOD OF CONSTRUCTING

(76) Inventor: Paul Irvin, Granite Shoals, TX (US)

(21) Appl. No.: 12/822,554

(22) Filed: Jun. 24, 2010

(51) Int. Cl. B65D 90/02; B23P 19/00

(52) U.S. Cl. 220/660; 29/428

(57) ABSTRACT

Provided herein is a modular rainwater collection system that may be easily transported through narrow openings (such as gates) and assembled with a minimum of tools. The rainwater collection system includes interlocking side panels that slide over one another to form the sides of the collection system. A liner installed within the collection system stores collected water. The modular assembly of the collection system allows for variations in height and shape to accommodate a homeowner's needs. Planter boxes or other storage containers may be hung on the exterior of the collection system for added functionality. A process for assembling the collection system is also provided.

### FIELD OF THE INVENTION

The present disclosure is directed to the field of rainwater collection systems.

### BACKGROUND OF THE INVENTION

Historically, water usage in the United States was primarily agricultural with a small percentage of water usage being for consumption by humans and animals and a small percentage being for cleaning dishes, clothes, and homes. To satisfy their need for non-potable water for agricultural purposes, farmers and other homeowners in rural settings collected rainwater in wooden water barrels for later use. These water barrels, while efficient for their purpose, were limited in size. Further, because the barrels were pre-assembled, they were difficult to ship and transport efficiently.

To accumulate a greater quantity of water and to hide the tank from view, some homeowners invest in underground rainwater collection tanks. Rainwater is collected from the rooftop and is transported through pipes to the underground collection tank from which it is later distributed to irrigation systems or to a hose for localized use. Such underground systems are expensive to purchase, to ship, and to install, requiring excavation of the homeowner's yard and usually requiring the hiring of a professional plumber or other installer. For many people, these types of systems are cost-prohibitive or inappropriate.

In modern society, homeowners use water in their bathrooms, in appliances (such as washing machines, dishwashers, and garbage disposals), and in their yards for watering their lawns and plants, for washing cars, and for refilling swimming pools. The demand for water is increasingly steadily with population growth and the depletion of natural aquifers in many areas. In some regions, water rationing has occurred. In response, many individuals in urban, suburban, and rural areas have become interested in this environmental issue and have realized the economies of water conservation.

To meet the demand for a rainwater collection container, manufacturers offer pre-fabricated vessels made of metal or a durable plastic, such as high density polyethylene, in a wide variety of sizes, ranging from 50 gallons to 1,000 gallons or more. Because they are already assembled, these vessels are expensive to ship, are hard to maneuver and install, and are limited to a particular size and shape (that is, cannot be easily expanded or contracted as needed). What is needed in the art is a modular rainwater containment system that is easily assembled and that is readily adaptable to different dimensions.

### SUMMARY OF THE INVENTION

A modular water collection system is provided herein. The modular water collection system includes a base and a number of sides surrounding the base and projecting upward from the base in a direction substantially perpendicular to the base to form a cavity for receipt and storage of water. Each side is made of a plurality of side panels that are interlocked by a slide seam. Each side panel includes a longitudinally extending central portion, an inverted J-shaped member projecting from a first edge of the central portion, and a modified, inverted J-shaped member projecting from a second edge opposite the first edge of the central portion, which defines a ledge for interlocking the inverted J-shaped member of an adjacent side panel. A liner for receiving and storing water is positioned within the cavity defined by the sides.

A method of constructing a modular water collection system is also provided. The method includes: providing a base; providing a plurality of interlocking side panels, each side panel comprising a longitudinally extending central portion, an inverted J-shaped member projecting from a first edge of the central portion, and a modified, inverted J-shaped member projecting from a second edge opposite the first edge of the central portion, the modified, inverted J-shaped member defining a ledge for interlocking; forming a plurality of sides by interlocking a number of the side panels by sliding the inverted J-shaped member of each panel into contact with the ledge of the modified, inverted J-shaped member of an adjacent side panel, thereby forming a slide seam; positioning the sides in an upright orientation, substantially perpendicular to the base and securing corner braces to the adjacent sides to form a cavity; and installing a liner within the cavity for receipt and storage of rainwater.

### BRIEF DESCRIPTION OF THE DRAWINGS

A full and detailed disclosure is set forth in the accompanying specification, which makes reference to the appended figures, in which:

FIG. 1 is a perspective view of a modular rainwater collection system, as described herein;

FIG. 2 is a perspective view of one of the side panels used in the construction of the modular rainwater collection system of FIG. 1, as viewed from an end of the side panel;

FIG. 3 is a cross-sectional view of a slide seam created by the interlocking engagement of two of the respective panels of FIG. 2;

FIG. 4 is a perspective view of the modular rainwater collection system of FIG. 1, as seen from above;

FIG. 5 is a perspective view of the interior of the modular rainwater collection system of FIG. 1, within which interior a liner is being installed; and

FIG. 6 is a perspective view of the modular rainwater collection system of FIG. 1, further including a number of planter containers.

### DETAILED DESCRIPTION

Reference is now made to the drawings for illustration of various components of the present modular rainwater collection system. While the particular illustrations provided herein are directed to a water collection system having a rectangular shape and a certain height, various elements and embodiments are equally applicable to creating water collection systems of other shapes and sizes. Moreover, while the side panels of the water collection system are described as being made of galvanized metal, the panels may be made of other durable materials instead. In addition, although a single water collection system is illustrated, multiple collection systems may be used in a single location, if so desired.

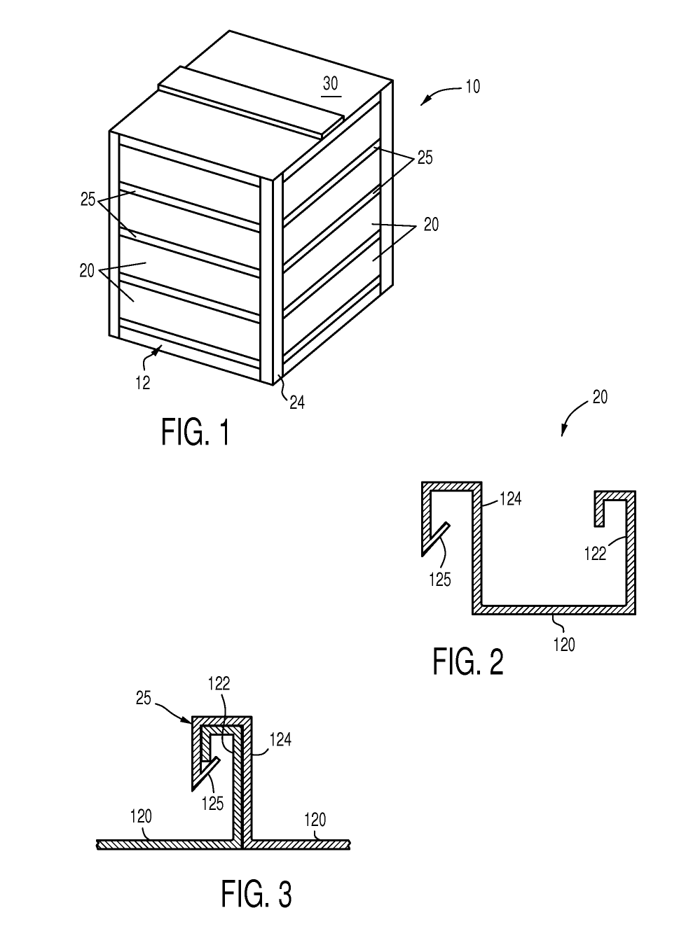

As shown in FIG. 1, a modular water collection system 10 is provided in the shape of a right rectangular prism having opposing sides oriented in parallel to one another and adjacent sides oriented perpendicularly to one another. The system 10 includes a bottom (not shown), sides 12, and a top cover 30. The sides 12 of the system 10 are joined by corner braces 24, which may be bolted or otherwise secured to the side panels 20. A liner 50 is fitted within the water collection system 10, as will be discussed below with respect to FIG. 5.

Each side 12 is made of a number of interlocking side panels 20 (shown in more detail in FIG. 2) that interlock by way of a slide seam 25 (shown in more detail in FIG. 3). Depending on the needs of the purchaser, any number of side panels 20 may be used to create a collection system 10 of a desired height. Each of the side panels 20 is provided with the same interlocking mechanism or profile, thereby leading to greater manufacturing efficiencies. In the case of a right rectangular prism shape, as shown, all of the side panels 20 have the same dimensions. If other shapes are desired for the collection system, the side panels 20 on different sides may have different lengths, as are necessary to create the desired shape. For example, the collection system 10 may be created in an L-shape or a U-shape.

The profile of the side panels 20 is shown mostly clearly in FIG. 2. The side panel 20 has a generally flat central portion 120. Generally, the central portion 120 has a length approximating the desired dimension of the collection system 10. As referenced above, if the collection system 10 is intended to have a longer dimension, the side panels 20 may be arranged in abutting, as well as stacked, relationship to one another to achieve the necessary dimensions, for instance, with an intermediate joining brace (not shown). Alternately, the side panels 20 may be made of a longer length to create the desired dimensions.

Projecting upward from one edge of the central portion 120 is a J-shaped member 122 that extends along the length of the side panel 20. The J-shaped member 122 has a first surface that is substantially perpendicular to the central portion 120 of the side panel 20; a second surface that is substantially perpendicular to the first surface and is substantially parallel to the central portion 120 and that extends over the central portion 120; and a third surface that is substantially perpendicular to the second surface and is substantially parallel to the first surface and that extends downwardly toward the central portion 120; such that the member 122 has the shape of an inverted letter “J”. The member 122 is formed as an integral structure for strength.

Extending along the length of the side panel 20 and projecting from the opposite edge of the central portion 120 is a modified J-shaped member 124 that is provided with a hooking ledge 125. The modified member 124 has a first surface that is substantially perpendicular to the central portion 120 of the side panel 20; a second surface that is substantially perpendicular to the first surface and is substantially parallel to the central portion 120 and that extends away from the central portion 120; and a third surface that is substantially perpendicular to the second surface and is substantially parallel to the first surface and that extends downwardly; such that the member 124 has the general shape of an inverted letter “J”. However, a hooking ledge 125 is provided at the end of the third surface of the member 124 opposite the location where the third surface connects to the second surface. The hooking ledge 125 and the third surface form an acute angle.

As shown in FIG. 3, the J-shaped member 122 of a first side panel 20 interlocks and is mated to the modified J-shaped member 124 of a second, adjacent side panel 20 to construct the collection system 10. As may be seen from reference to FIG. 3, the J-shaped member 122 is slightly smaller than the modified J-shaped member 124, thus permitting the nesting of the member 122 within the profile of the member 124. The ledge 125 hooks over the downwardly projecting third surface of the member 122 to form an interlocking mechanism between the adjacent side panels 20. The interlocking mechanism may be described as a “slide seam” 25, in which the adjacent panels 20 are joined by sliding one panel over the other to form a durable connection.

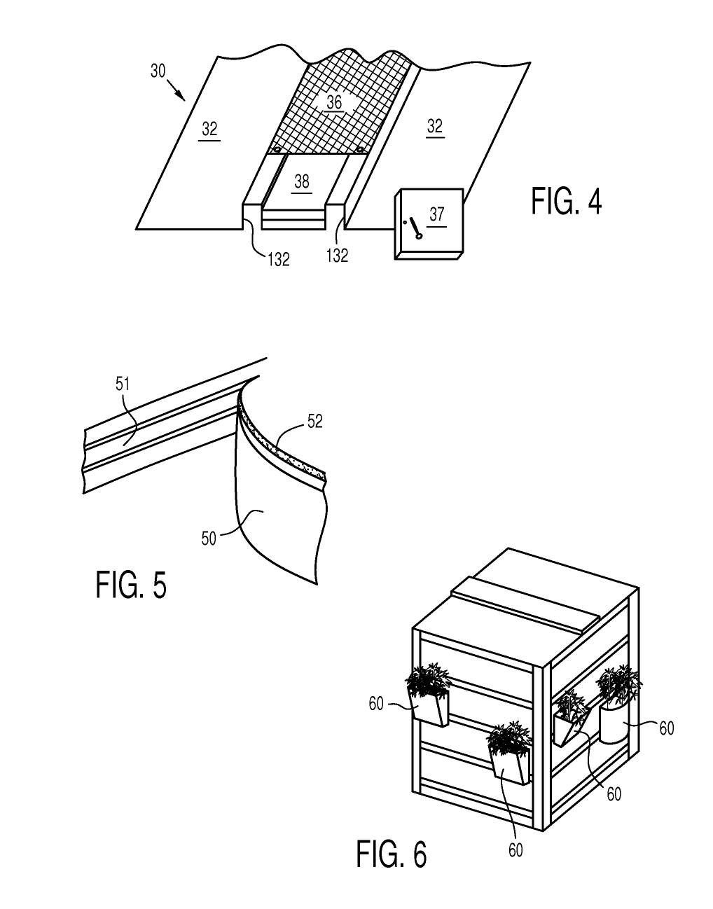

The top 30 of the collection system 10 is shown in FIG. 4. The top 30 includes an opening 38 for receipt of rainwater, the opening 38 being located between the top surface covers 32. The top surface covers 32 may be provided with inverted J-shaped ridges 132 that project upward from the covers 32 to form an overflow passage. The ridges 132 may be oriented such that the open portions of the ridges 132 face one another, as shown, and the vertically oriented first surfaces of the J-shaped ridges 132 are positioned outboard of the opening 38 in the top 30 of the collection system 10. A supplemental cover panel 36 spans the area between the J-shaped ridges 132 and is bolted, or otherwise connected, to the J-shaped ridges 132. The opening 38 receives rainwater within the collection system 10, for instance, by being positioned at the end of a gutter system (not shown). The opening 38 may be covered, if desired, for instance, when the collection system 10 is full, by a lid 37 that is secured with a cotter pin or other easily removable fastening element.

FIG. 5 illustrates the interior of the collection system 10. Around the interior perimeter of the uppermost side panels of the collection system 10, a liner holder 51 is secured. A liner 50, which is made of a durable watertight material, such as vinyl, is provided with an edge that functions as a gasket 52. The gasket 52 engages the trough within the liner holder 51 to form a secure juncture between the liner 50 and the collection system 10. The liner 50 is provided with a valve and hose attachment (not shown) at the bottom, which extend through one of the side panels 20 for removing water from the collection system 10. The liners 50 may be made in a variety of sizes to accommodate collection systems 10 of differing sizes.

The slide seams 25 of the collection system 10 provide a number of surfaces to which vessels may be removably attached. For example, FIG. 6 shows the attachment of a number of planter boxes to the sides 12 of the collection system 10. The planter boxes 60 may be used to beautify the collection system 10 and the surrounding yard in which the collection system 10 is located. It has been found that, if the planter boxes are provided with drainage holes and are vertically aligned with one another, the water applied to a plant in an upper planter box will drain through to a plant in a lower planter box. Alternately, other types of vessels (such as storage containers) may be used in addition to, or instead of, the planter boxes 60 that are illustrated. The storage containers may be used for gardening tools or supplies, sporting equipment, pool supplies, and the like. The collection system 10 may also function as a privacy screen or a wall for back yards.

Assembly of the water collection system may be accomplished quickly. The consumer orients the base in the desired location. For each side (12), a number of side panels (20) are joined together by sliding adjacent panels over one another to form an interlocked slide seam (25) between them. When each side is assembled, the sides (12) are oriented in an upright position, substantially perpendicular to the base, and are joined together by the corner braces (24). The corner braces (24) are bolted to the side panels (20) to secure the component parts together and to form a cavity for receipt and storage of water. The liner holder (51) is then installed around the interior perimeter of the uppermost side panels (20), and the liner (50) is installed, such that the plumbing connections are oriented toward the bottom of the system. The top panels (32) are then bolted into position over the cavity to define an opening through which water is captured by the system (10).

Because the system 10 is assembled on-site, rather than being pre-fabricated as a unit, many advantages are realized. First, shipping costs are reduced, since the component parts may be nested together for compact shipment. In addition, the component parts (for example, the side panels 20) may be easily transported through passageways of any size, thereby permitting the installation of the collection system 10 in back yards or other areas that are accessible only through a narrow gate opening, for instance. The assembly of the component parts is quickly accomplished with a minimum of tools, resulting in a sleek, modern appearance.

Further, if future needs dictate, the water collection system 10 may be modified by the simple addition of more side panels 20 to create a vessel with a greater volume. Alternately, the water collection system 10 may be expanded to different dimensions (shape and/or height) by the use of interlocking side panels 20 appropriately sized for the desired configuration. By way of example and not of limitation, the water collection system may be configured in an L-shape or a U-shape, in which some side panels 20 are longer than others. Another option uses a joining element (similar to corner joints 24) to connect adjacent side panels 20 along a single side. Yet another option for expansion of the water collection system is to use two units (e.g., 10) in a side-by-side arrangement, such that when the first unit is full, water flows directly into the neighboring second unit by way of the overflow area at the top of the unit.

The preceding discussion merely illustrates the principles of the present modular rainwater collection system. It will thus be appreciated that those skilled in the art may be able to devise various arrangements, which, although not specifically shown or described herein, embody the principles of the invention and are included within its spirit and scope. Furthermore, all examples are conditional language recited herein are principally intended for educational purposes and to aid the reader in understanding the principles of the invention and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

What is claimed is:

1. A modular water collection system comprising:
a base;
a number of sides surrounding the base and projecting upward from the base in a direction substantially perpendicular to the base to form a cavity for receipt and storage of water, each side comprising a plurality of side panels, the side panels being interlocked by a slide seam, each side panel comprising a longitudinally extending central portion, an inverted J-shaped member projecting from a first edge of the central portion, and a modified, inverted J-shaped member projecting from a second edge opposite the first edge of the central portion, the modified, inverted J-shaped member defining a ledge for interlocking the inverted J-shaped member of an adjacent side panel; and
a liner for receiving and storing water, the liner being positioned within the cavity defined by the sides.

2. The modular water collection system of claim 1, wherein the base and the side panels are comprised of galvanized metal.

3. The modular water collection system of claim 1, further comprising corner braces, the corner braces being attached to the side panels to hold the sides together.

4. The modular water collection system of claim 1, further comprising a top cover, the top cover defining an opening therethrough for receipt of rainwater.

5. The modular water collection system of claim 4, wherein the top cover comprises a pair of oppositely disposed ridges and a supplemental cover panel secured to and spanning a majority of the length of the oppositely disposed ridges, the ridges and the supplemental cover panel defining the opening for receipt of rainwater.

6. The modular water collection system of claim 5, further comprising a removable lid, the removable lid being configured to cover the opening and being secured by a removable fastener.

7. The modular water collection system of claim 1, further comprising a valve and a hose connection, the valve and the hose connection being attached to the liner for distribution of water stored within the water collection system.

8. The modular water collection system of claim 1, wherein the cavity defines the shape of a rectangular prism.

9. The modular water collection system of claim 1, wherein the cavity defines an L-shape.

10. The modular water collection system of claim 1, wherein the cavity defines a U-shape.

11. The modular water collection system of claim 1, further comprising a vessel removably attached to an exterior surface of one of the sides.

12. The modular water collection system of claim 11, wherein the vessel is a planter box.

13. The modular water collection system of claim 11, wherein the vessel is a storage container.

14. A method of constructing a modular water collection system, the method comprising:
providing a base;
providing a plurality of interlocking side panels, each side panel comprising a longitudinally extending central portion, an inverted J-shaped member projecting from a first edge of the central portion, and a modified, inverted J-shaped member projecting from a second edge opposite the first edge of the central portion, the modified, inverted J-shaped member defining a ledge for interlocking;
forming a plurality of sides by interlocking a number of the side panels by sliding the inverted J-shaped member of each panel into contact with the ledge of the modified, inverted J-shaped member of an adjacent side panel, thereby forming a slide seam; positioning the sides in an upright orientation, substantially perpendicular to the base, and securing corner braces to the adjacent sides to form a cavity; and
installing a liner within the cavity for receipt and storage of rainwater.

15. The method of claim 14, further comprising installing a liner holder around the interior perimeter of the uppermost side panels, the liner holder comprising a trough to which the liner is attached.

16. The method of claim 14, further comprising securing a plurality of top covers to the water collection system to define an opening for collection of rainwater.

17. The method of claim 14, further comprising providing the liner with a valve and hose connection for distribution of collected rainwater.

18. The method of claim 14, further comprising attaching a planter box or storage container to the exterior side of the water collection system.

19. The method of claim 14, wherein the base and the side panels are comprised of galvanized metal.

20. The method of claim 14, further comprising orienting a second collection system adjacent the first collection system to capture overflow.
